(19) United States
(12) Patent Application Publication
(10) Pub. No.: US 2007/0155223 A1
(43) Pub. Date: Jul. 5, 2007

(54) Connector and indicator thereof

(75) Inventors: Ru-Kuen Huang, Taoyuan Hsien (TW); Chieh-Cheng Chen, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/648,786

(22) Filed: Jan. 3, 2007

(30) Foreign Application Priority Data
Jan. 3, 2006 (TW) 095100195

(51) Int. Cl. H01R 3/00

(52) U.S. Cl. 439/490

(57) ABSTRACT

A connector includes an indicator and a connector body. The indicator includes a light-emitting part and an extension body. The extension body covers the light-emitting part. The extension body and the light-emitting part are integrally formed as a single piece. The connector body has an accommodation space which at least one portion of the extension body is disposed therein.

### BACKGROUND OF THE INVENTION

1. Field of Invention

The present invention relates to a connector and an indicator thereof, and more particularly to a connector with non-rectangular block type indicator and an indicator of the connector.

2. Related Art

Due to light emitting diode (LED) has the advantages of anti-shock, longer lifetime, less power consumption and less heat dissipated, the application of LED has gradually extended to a variety of daily-life appliances, for example the LED is as an indicator, an lighting or an backlighting of family appliances or instruments, since it is commercialized after 1960s.

LED is also applied in a connector such as communication network (RJ45) connector for indicating the operation state of the connector. As shown in FIGS. 1 and 2, an indicator 12 is fixed adjacent to a back end of a conventional connector 11. A transparent light-guiding element 13 is then assembled in the connector 11 for guiding the light beam emitted from the indicator 12 to a front of the connector 11 so as to indicate the operation state of the connector 11. The optical path is shown as the arrows.

Due to the indicator 12 and the transparent light-guiding element 13 are separated elements, more assembly processes are needed which lead to low throughput and are hard to perform quality control. In addition, the connecting interface between the indicator 12 and the transparent light-guiding element 13 causes lots of optical loss because they are separated.

Accompanying with shrinkage and integration of electronic products, electromagnetic interference (EMI) between electronic devices seriously influences the performance and reliability of the electronic products. When the connector 11 is applied, the indicator 12 is easily influenced by EMI or influences on other internal elements of the connector 11 because the indicator 12 and the circuits of the connector 11 are located in the same casing.

As shown in FIG. 3, an indicator 21 is disposed adjacent to a back end of another conventional connector 22. The casing of the connector 22 is made of transparent material to transmit the light beam from the indicator 21. However, the indicator 21 and the transparent casing of the connector 22 are also separated elements, and the connecting interface between them still causes lots of optical loss. In addition, the indicator 21 is easily influenced by EMI or influences on other internal elements of the connector 22 because the indicator 21 is still located in the casing of the connector 22.

It is thus imperative to provide a connector and an indicator thereof capable of easy assembly with cooperated electronic products for reducing the manufacturing cost and optical loss, preventing from electromagnetic interference, and ensuring the performance and reliability of the connector.

### SUMMARY OF THE INVENTION

In view of the foregoing, the present invention provides a connector and an indicator thereof capable of easy assembly with cooperated electronic products for reducing the manufacturing cost and optical loss, preventing from electromagnetic interference, and ensuring the performance and reliability of the connector.

To achieve the above, a connector according to the present invention includes an indicator and a connector body. The indicator has a light-emitting part and an extension body. The extension body covers the light-emitting part, and the extension body and the light-emitting part are integrally formed as a single piece. The connector body has an accommodation space which at least one portion of the extension body is disposed therein. The indicator can be in L type, U type or other non-rectangular type.

To achieve the above, an indicator according to the present invention includes a light-emitting part and an extension body. The extension body covers the light-emitting part. The extension body and the light-emitting part are integrally formed as a single piece. The indicator can be in L type, U type or other non-rectangular type.

As mentioned above, a connector and an indicator thereof according to the present invention integrally forms the extension body and the light-emitting part as a single piece for easy assembly with cooperated electronic products, shortening the producing time and reducing the manufacturing cost. Due to less elements and no connecting interface between the light-emitting part and the extension body, the indicator has almost no optical loss and is easy to perform quality control. In addition, at least one portion of the extension body of the indicator is disposed in the accommodation space of the connector body such that the light-emitting part may not be disposed in the connector body. Thus, electromagnetic interference between the indicator and the connector can be prevented, which ensures the performance and reliability of the connector.

### BRIEF DESCRIPTION OF THE DRAWINGS

The present invention will become more fully understood from the detailed description given herein below illustration only, and thus are not limitative of the present invention, and wherein:

FIG. 1 is a three-dimensional exploded diagram showing a conventional connector and an indicator;

FIG. 2 is a cross-sectional diagram showing the conventional connector and the indicator,

FIG. 3 is a cross-sectional diagram showing another conventional connector and an indicator,

FIG. 4 is a schematic diagram showing an indicator according to a preferred embodiment of the present invention;

FIG. 5 is a three-dimensional exploded diagram showing a connector and an indicator according to a preferred embodiment of the present invention;

FIG. 6 is a three-dimensional diagram showing the connector and the indicator according to the preferred embodiment of the present invention;

FIG. 7 is a cross-sectional diagram showing the connector and the indicator according to the preferred embodiment of the present invention; and

FIG. 8 is a cross-sectional diagram showing another connector and an indicator according to a preferred embodiment of the present invention.

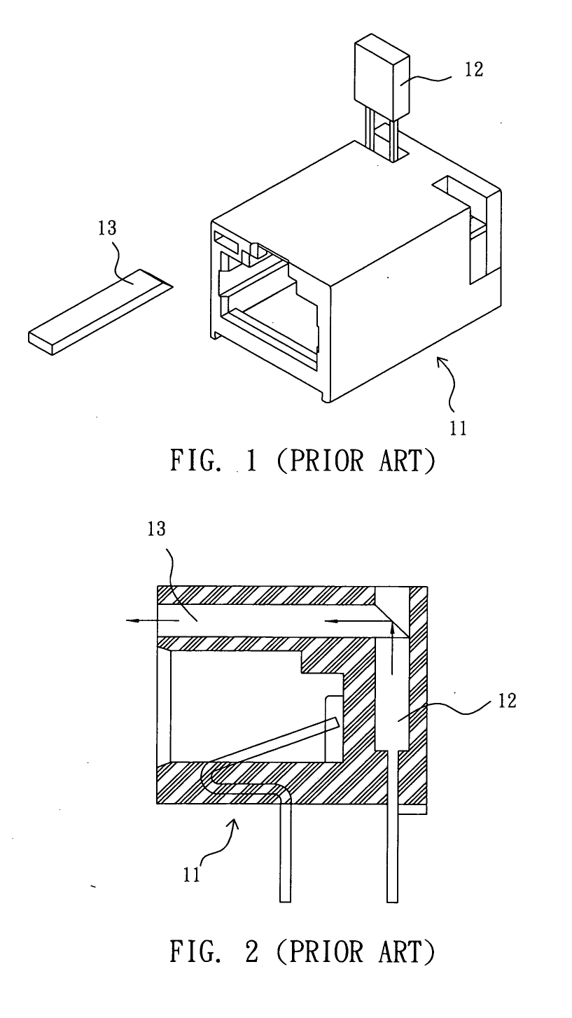

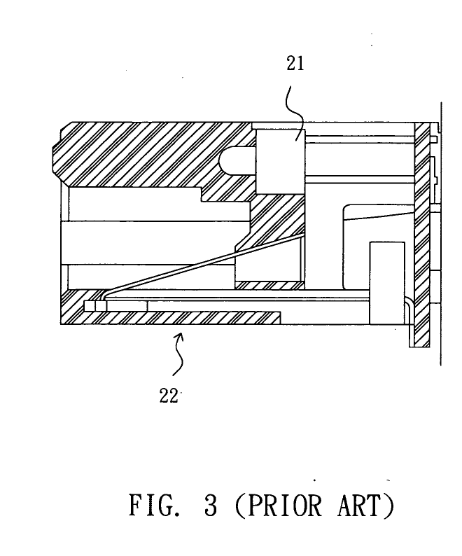

### DETAILED DESCRIPTION OF THE INVENTION

The present invention will be apparent from the following detailed description, which proceeds with reference to the accompanying drawings, wherein the same references relate to the same elements.

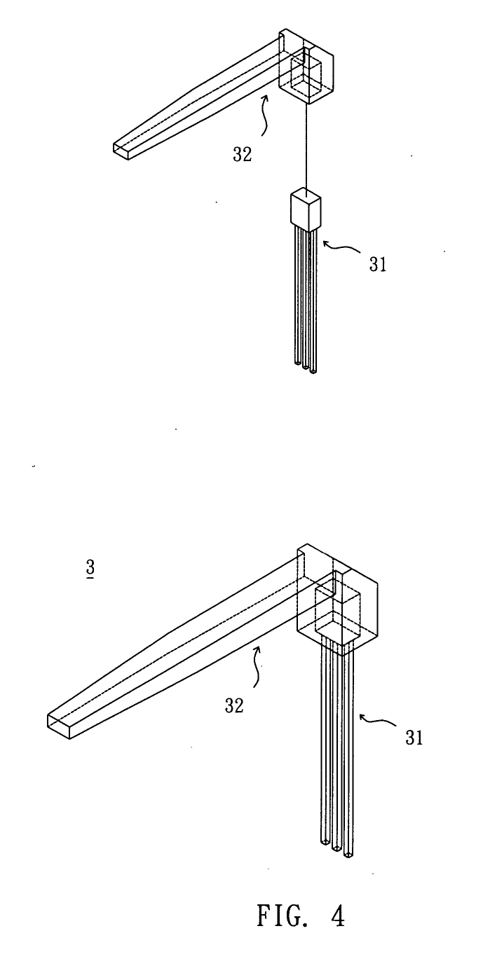

As shown in FIG. 4, an indicator 3 according to a preferred embodiment of the present invention is used for connecting with a connector. The indicator 3 includes a light-emitting part 31 and an extension body 32. The light-emitting part 31 and the extension body 32 are integrally formed as a single piece. The indicator 3 may be a LED or an organic electroluminescent device (OELD).

The indicator 3 may be integrally formed as a single piece by molding for example. The manufacture of the indicator 3 includes the steps of designing a mold in accordance with the shape and scale of the extension body 32; disposing the light-emitting part 31 into the mold; and integrally forming the extension body 32 by plastic material for covering the light-emitting part 31. In this embodiment, the plastic material may be polymethylmethacrylate (PMMA) or polycarbonate (PC), and which is advantageous to lower molding temperature, higher transparency and mobility, and facilitate the molding of slender body.

The extension body 32 covers the light-emitting part 31, and guides the light beam emitted from the light-emitting part 31 to a surface of the extension body 32 apart from the light-emitting part 31. The extension body 32 may be shaped as a strip type, a L type, a U type, a non-rectangular type or any other types in accordance with actual requirement. The extension body 32 may be hollow or solid. In this embodiment, the extension body 32 is made of transparent material or translucent material. In addition, a reflective material layer, an optical absorbable material layer, a heatproof material layer, an anti-electromagnetic wave layer or any other functional layers may be further disposed on the inner wall or outer wall of the extension body 32. The light-emitting part 31 may be a LED, an OELD or any other light-emitting elements acting as a light source of the indicator 3.

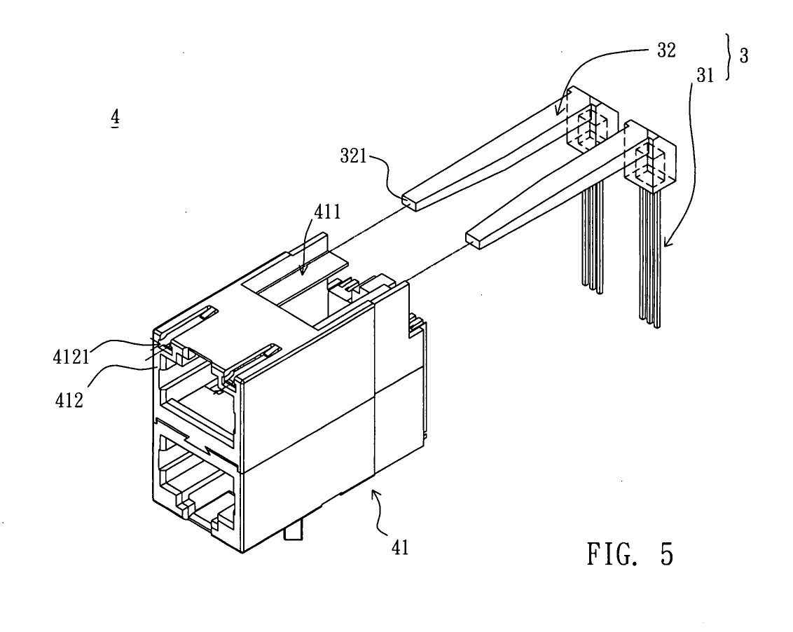

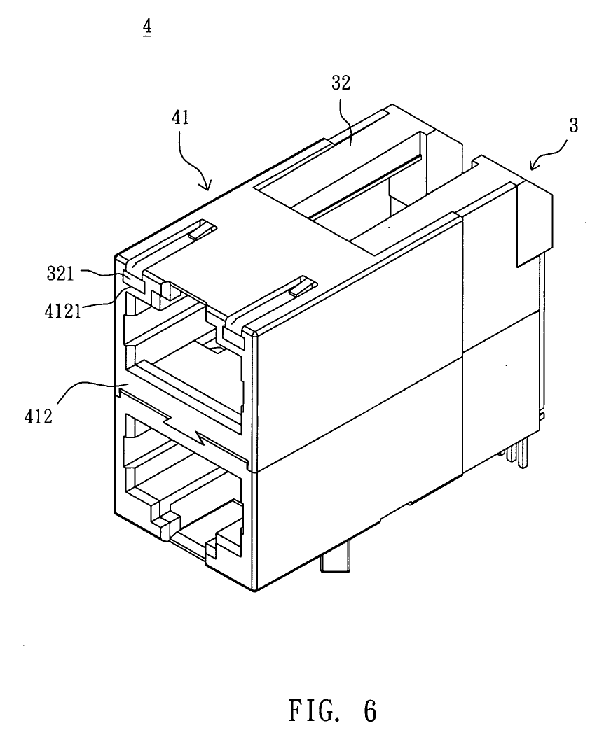

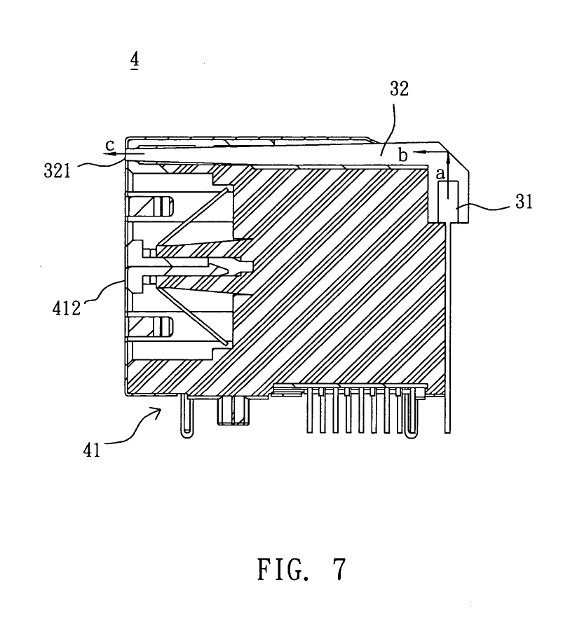

As shown in FIGS. 5 and 6, a connector 4 according to a preferred embodiment of the present invention is constructed from the indicator 3 and a connector body 41. The connector body 41 further includes terminals and other electronic devices therein. An accommodation space 411 and a front 412 are outside of the connector body 41. The accommodation space 411 may be located at outer back of the connector body 41. At least one portion of the extension body 32 is disposed in the accommodation space 411. The front 412 of the connector body 41 has an opening 4121, and a surface 321 of the extension body 32 is substantially level with the opening 4121. In addition, the surface 321 of the extension body 32 may be located within or protruded from the opening 4121.

As shown in FIG. 7, the light beam emitted from the light-emitting part 31 (optical path a) is transmitted within the extension body 32 (optical path b), and then transmitted out through the surface 321 of the extension body 32 (optical path c) so as to indicate the operation state of the connector 4. Due to no connecting interface between the light-emitting part 31 and the extension body 32, the strength of the light beam transmitted within the indicator 3 will not weaken such that the optical loss can be prevented. In this embodiment, the connector body 41 may be a RJ-45 connector, a RJ-12 connector or any other types of connector.

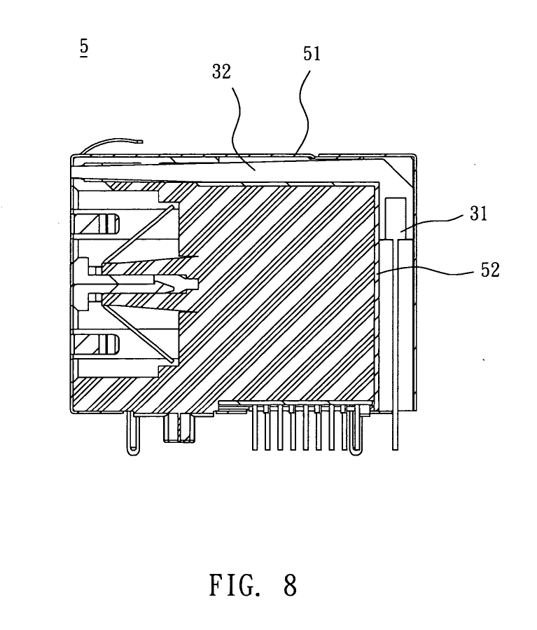

As shown in FIG. 8, another connector 5 according to a preferred embodiment of the present invention includes an isolation part 52 and a casing 51. The isolation part 52 covers the connector body 41. The casing 51 covers the isolation part 52. The accommodation space 411 is located between the casing 51 and the isolation part 52. In addition, the casing 51 and the connector 5 may be separated from each other. Due to the indicator 3 is located between the isolation part 52 and the casing 51, which the indicator 3 is protected and prevented from external reaction.

In summary, a connector and an indicator thereof according to the present invention integrally forms the extension body and the light-emitting part as a single piece for easy assembly with cooperated electronic products, shortening the producing time and reducing the manufacturing cost. Due to less elements and no connecting interface between the light-emitting part and the extension body, the indicator has almost no optical loss and is easy to perform quality control. In addition, at least one portion of the extension body of the indicator is disposed in the accommodation space of the connector body such that the light-emitting part may not be disposed in the connector body. Thus, electromagnetic interference between the indicator and the connector can be prevented, which ensures the performance and reliability of the connector.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A connector comprising:
an indicator having a light-emitting part and an extension body, for covering the light-emitting part, wherein the extension body and the light-emitting part are integrally formed as a single piece; and
a connector body having an accommodation space for disposing at least one portion of the extension body therein.

2. The connector according to claim 1, wherein the extension body and the light-emitting part are integrally formed as a single piece by molding.

3. The connector according to claim 1, wherein the indicator is a LED or an OELD.

4. The connector according to claim 1, wherein the extension body is shaped as a strip type, a L type, a U type or a non-rectangular type.

5. The connector according to claim 1, wherein the extension body guides a light beam emitted from the light-emitting part to a surface of the extension body, which is apart from the light-emitting part.

6. The connector according to claim 5, wherein the connector body has an opening, and the surface of the extension body is located within, protruded from, or substantially leveled with the opening.

7. The connector according to claim 1, wherein the extension body is made of polymethylmethacrylate, polycarbonate, a transparent material or a translucent material.

8. The connector according to claim 1, wherein the extension body is hollow or solid.

9. The connector according to claim 1, wherein the extension body has a reflective material layer, an optical absorbable material layer, a heatproof material layer or an anti-electromagnetic wave layer on a side wall thereof.

10. The connector according to claim 1, wherein the connector body is a RJ-type connector or a RJ45 connector.

11. The connector according to claim 1, further comprising:
an isolation part covering the connector body; and
a casing covering the isolation part, wherein the indicator is located between the isolation part and the casing.

12. The connector according to claim 11, wherein the casing and the connector body are separated from each other.

13. The connector according to claim 1, wherein the accommodation space is located outside the connector body.

14. An indicator, comprising:
a light-emitting part; and
an extension body covering the light-emitting part;
wherein the extension body and the lightemitting part are integrally formed as a single piece.

15. The indicator according to claim 14, wherein the light-emitting part is a LED or an OELD.

16. The indicator according to claim 14, wherein the extension body is shaped as a strip type, a L type, a U type or a non-rectangular type.

17. The indicator according to claim 14, wherein the extension body guides a light beam emitted from the light-emitting part to a surface of the extension body, which is apart from the light-emitting part.

18. The indicator according to claim 14, wherein the extension body is made of polymethylmethacrylate, polycarbonate, a transparent material or a translucent material.

19. The indicator according to claim 14, wherein the extension body is hollow or solid.

20. The indicator according to claim 14, wherein the extension body has a reflective material layer, an optical absorbable material layer, a heatproof material layer or an anti-electromagnetic wave layer on a side wall thereof.
